(19) United States
(12) Patent Application Publication
(10) Pub. No.: US 2025/0375791 A1
(43) Pub. Date: Dec. 11, 2025

(54) COATING APPARATUS MODULE

(71) Applicant: SK ON CO., LTD., Seoul (KR)

(72) Inventor: Ju Hyun KIM, Daejeon (KR)

(21) Appl. No.: 19/216,656

(22) Filed: May 22, 2025

(30) Foreign Application Priority Data
Jun. 5, 2024 (KR) 10-2024-0073820

(51) Int. Cl. B05C 21/00

(52) U.S. Cl. CPC B05C 21/00

(57) ABSTRACT

Proposed is a coating apparatus module including a main body including a lower plate, a middle plate joined on the lower plate, an upper plate joined on the middle plate, an upper core member coupled to the upper plate and the middle plate at a position therebetween to form an upper discharge part through which a coating solution is discharged, and a lower core member coupled to the middle plate and the lower plate at a position therebetween to form a lower discharge part through which a coating solution is discharged, wherein the main body is combined with at least one height adjustment part to adjust heights of the upper discharge part and the lower discharge part.

### CROSS REFERENCE TO RELATED APPLICATION

The present application claims priority to Korean Patent Application No. 10-2024-0073820, filed June 5, 2024, the entire contents of which is incorporated herein for all purposes by this reference.

### BACKGROUND OF THE INVENTION

### FIELD OF THE INVENTION

The present disclosure relates to a coating apparatus module.

### DESCRIPTION OF THE RELATED ART

In recent years, mobile devices such as mobile phones and laptops are becoming smaller and lighter. Furthermore, as higher capacity batteries are needed for electric vehicles and hybrid vehicles, a variety of batteries are being developed and used as a source of power. Electrode plates used in secondary batteries and capacitors are produced by applying and drying electrode powder, etc., in the form of slurry on the surface of a support material.

However, in the process of applying coating solution in the form of slurry to the surface of a support material, it is difficult for a single coating device to cover the required degree of solution, coating width, and specifications for application to various products, and thus the development of a coating device to improve productivity and efficiency of the work is becoming necessary.

### Document of Related Art

(Patent Document 1) Korean Patent No. 10-2456715

### SUMMARY OF THE INVENTION

According to an aspect of the present disclosure, provided is a coating apparatus module that allows dual coating and single coating to be performed more stably without replacing an apparatus.

According to another aspect of the present disclosure, provided is a coating apparatus module that enables effective coating by changing or adjusting the position of coating application of a coating apparatus according to the height difference between the coating apparatus and a coating roll, and a rib for a single-type or dual-type coating process.

A coating apparatus module according to an embodiment of the present disclosure may include: a main body including: a lower plate; a middle plate joined on the lower plate; an upper plate joined on the middle plate; an upper core member coupled to the upper plate and the middle plate at a position therebetween to form an upper discharge part through which a coating solution is discharged; and a lower core member coupled to the middle plate and the lower plate at a position therebetween to form a lower discharge part through which a coating solution is discharged, wherein the main body may be combined with at least one height adjustment part to adjust heights of the upper discharge part and the lower discharge part.

In this case, the apparatus may further include: a first sensor part configured to sense a height of the main body; a second sensor part configured to sense a height of a coating roll coated by the main body; and a controller configured to sense a height difference between the heights sensed by the first sensor part and the second sensor part and to drive the height adjustment part of the main body.

In addition, the height adjustment part may include: a first adjustment part coupled to a first side of the lower plate of the main body; and a second adjustment part coupled to a second side of the lower plate of the main body, wherein the first adjustment part and the second adjustment part may be coupled to an adjustment joint part of the lower plate.

In addition, the first adjustment part and the second adjustment part may have a screw shape and may rotate to adjust a height of the main body.

In addition, the apparatus may further include: an upper manifold provided on an inner surface of the upper plate facing the upper plate and the middle plate to supply a coating solution to the upper discharge part; and a lower manifold provided on an inner surface of the middle plate facing the middle plate and the lower plate to supply a coating solution to the lower discharge part.

A coating apparatus module according to another embodiment of the present disclosure may include: a main body including: a lower plate; a middle plate joined on the lower plate; an upper plate joined on the middle plate; an upper core member coupled to the upper plate and the middle plate at a position therebetween to form an upper discharge part through which a coating solution is discharged; and a lower core member coupled to the middle plate and the lower plate at a position therebetween to form a lower discharge part through which a coating solution is discharged; and an adjustment rib provided at an end of the middle plate or the lower plate, on a side of the lower discharge part, and separately coupled to open and close the lower discharge part.

In this case, the adjustment rib may be coupled to the middle plate or the lower plate, and may include a fastening part so as to join to a fastening groove provided at an end of the middle plate or the lower plate.

In addition, the fastening groove may be provided on an inner side of a side of the middle plate or the lower plate, and may be formed so that the fastening part is fitted into an end thereof.

In addition, the main body may be combined with at least one height adjustment part to adjust heights of the upper discharge part and the lower discharge part.

In addition, the height adjustment part may include: a first adjustment part coupled to a first side of the lower plate of the main body; and a second adjustment part coupled to a second side of the lower plate of the main body, wherein the first adjustment part and the second adjustment part may be coupled to an adjustment joint part of the lower plate.

In addition, the apparatus may further include: an upper manifold provided on an inner surface of the upper plate facing the upper plate and the middle plate to supply a coating solution to the upper discharge part; and a lower manifold provided on an inner surface of the middle plate facing the middle plate and the lower plate to supply a coating solution to the lower discharge part.

In addition, the apparatus may further include: a first sensor part configured to sense a height of the main body; a second sensor part configured to sense a height of a coating roll coated by the main body; and a controller configured to sense a height difference between the heights sensed by the first sensor part and the second sensor part and to drive the height adjustment part of the main body.

The features and advantages of the present disclosure will become more apparent from the following detailed description based on the accompanying drawings.

Prior to this, terms or words used in this specification and claims should not be construed in their usual, dictionary meaning, and should be interpreted with meaning and concept consistent with the technical idea of the present disclosure on the basis of the principle that the inventor can define terminology appropriately to explain his or her invention in the best way possible.

According to an embodiment of the present disclosure, both single coating and dual coating processes can be performed.

Furthermore, the height at which coating solution is sprayed can be effectively adjusted in accordance with the position of a coating roll, coating thickness, and coating range.

Furthermore, by facilitating the design change of a lower plate for height adjustment of a coating apparatus, the reliability of coating solution discharge according to height change can be improved.

### BRIEF DESCRIPTION OF THE DRAWINGS

FIG. 1 is a cross-sectional view of a main body of a coating apparatus module according to an embodiment of the present disclosure.

FIG. 2 is a schematic exploded perspective view of the main body of FIG. 1.

FIGS. 3 and 4 are cross-sectional schematic views of a coating apparatus module before and after operation according to an embodiment of the present disclosure.

FIG. 5 is a schematic view of the operation of a coating apparatus module according to a modified example of an embodiment of the present disclosure.

FIG. 6 is a cross-sectional view before adjustment of an adjustment lip of a coating apparatus module according to another embodiment of the present disclosure.

FIGS. 7 and 8 are cross-sectional views after adjustment of an adjustment rib of a coating apparatus module according to another embodiment of the present disclosure.

FIG. 9 is an exploded perspective view of an adjustment rib of a coating apparatus module according to another embodiment of the present disclosure.

### DETAILED DESCRIPTION OF THE INVENTION

Terms used to describe an embodiment of the present disclosure are not intended to limit the disclosure. It should be noted that singular expressions include plural expressions unless the context clearly dictates otherwise.

It should be noted that, in assigning reference numerals to components in the drawings, identical components are assigned the same reference numerals as much as possible even if they are shown in different drawings, and similar reference numbers are assigned to similar components.

The drawings may be schematic or exaggerated for the purpose of illustrating the embodiments. In this document, expressions such as "have", "may have", "include", or "may include" refer to the presence of the corresponding feature (e.g., a numerical value, function, operation, or component such as a part), and do not exclude the presence of additional features.

Terms such as "one", "other", "another", "first", "second", etc., are used to distinguish one component from another component, and the components are not limited by the terms. Hereinafter, an embodiment of the present disclosure will be described in detail with reference to the attached drawings.

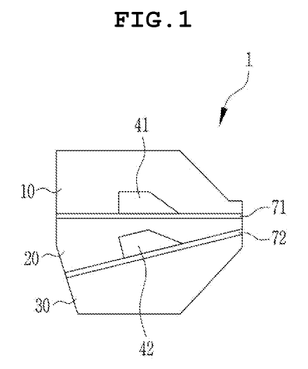

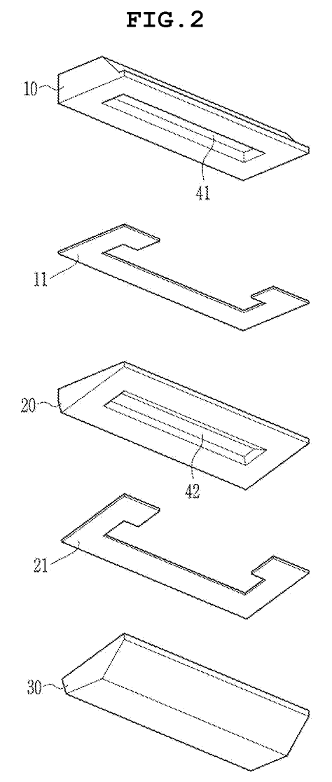

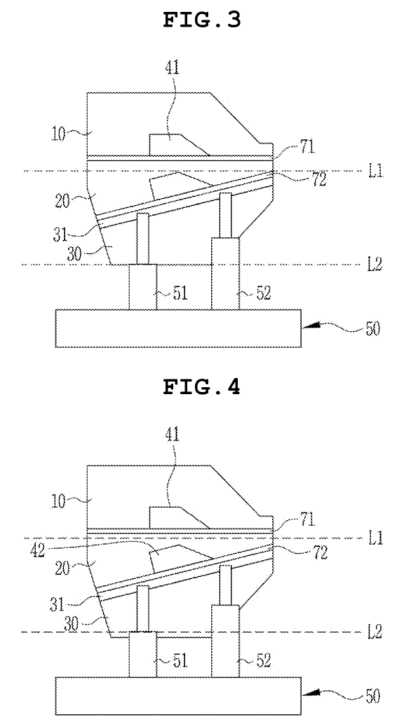

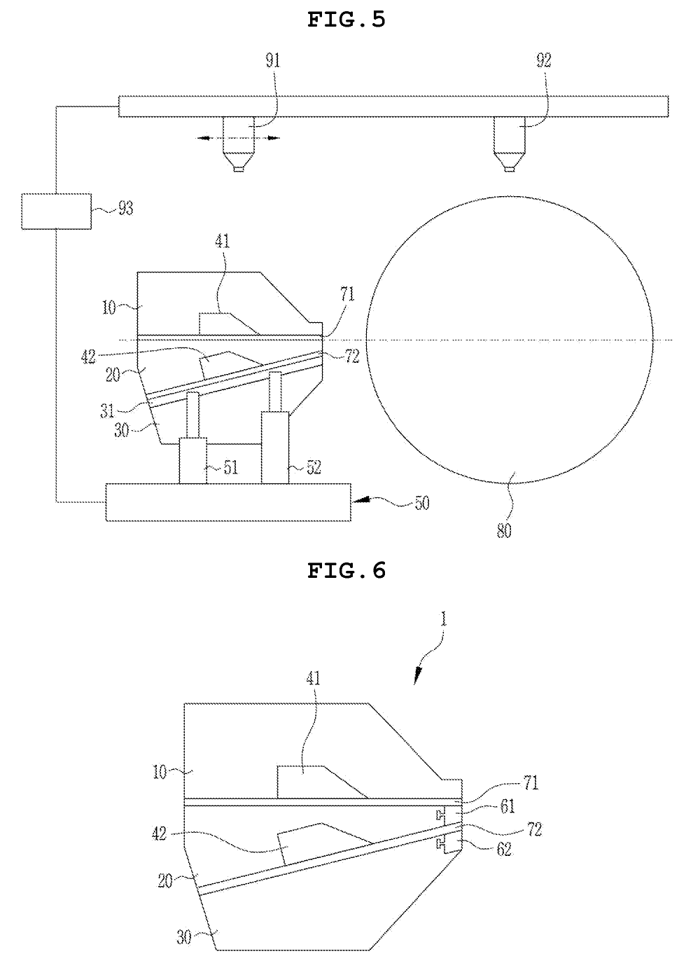

FIG. 1 is a cross-sectional view of a main body of a coating apparatus module according to an embodiment of the present disclosure; FIG. 2 is a schematic exploded perspective view of the main body of FIG.1; FIGS. 3 and 4 are cross-sectional schematic views of a coating apparatus module before and after operation according to an embodiment of the present disclosure; and FIG. 5 is a schematic view of the operation of a coating apparatus module according to a modified example of an embodiment of the present disclosure.

A coating apparatus module according to an embodiment of the present disclosure may include a main body 1 including: a lower plate 30; a middle plate 20 joined on the lower plate 30; an upper plate 10 joined on the middle plate 20; an upper core member 11 that is coupled to the upper plate 10 and the middle plate 20 at a position therebetween to form an upper discharge part 71 through which a coating solution is discharged; and a lower core member 21 that is coupled to the middle plate 20 and the lower plate 30 at a position therebetween to form a lower discharge part 72 through which a coating solution is discharged. In addition, the main body 1 may be combined with at least one height adjustment part 50 to adjust the heights of the upper discharge part 71 and the lower discharge part 72.

As shown in FIG. 1, the main body 1 of the coating apparatus module according to an embodiment of the present disclosure is formed by combining the upper plate 10, the middle plate 20, and the lower plate 30.

The lower plate 30 may be attached to the bottom of the main body 1, and the middle plate 20 may be attached on top of the lower plate 30.

As shown in FIG. 2, the lower core member 21 may be coupled to the lower plate 30 and the middle plate 20 at a position therebetween so that the coating solution may be discharged. The lower core member 21 may appropriately adjust the thickness or width of the coating discharge. The lower core member 21 may form the lower discharge part 72 between the lower plate 30 and the middle plate 20.

The upper plate 10 may joined on the middle plate 20, and the upper core member 11 may be coupled to the middle plate 20 and the upper plate 10 at a position therebetween. As shown in FIG. 2, like the lower core member 21, the upper core member 11 may also form the upper discharge part 71 between the middle plate 20 and the upper plate 10, and due to this, the coating solution inside may be discharged toward a coating roll 80, the coating target, to perform coating.

The upper core member 11 and the lower core member 21 may be combined such that the coating solution is discharged through an open portion in the width direction toward the upper discharge part 71 and the lower discharge part 72. Depending on the thicknesses of the upper core member 11 and the lower core member 21 or the open width of the front surfaces, the width and thickness of the coating solution discharged through the upper discharge part 71 and the lower discharge part 72 may be appropriately adjusted.

The upper plate 10 may be provided with an upper manifold 41 configured to accommodate a coating solution therein so that the coating solution may be discharged through the upper discharge part 71. In the illustrated drawing, the coating solution may be supplied from the upper manifold 41 to the upper discharge part 71 in the direction of gravity. Thus, the upper manifold 41 may stably supply the coating solution to the upper discharge part 71 even when the main body 1 is driven to adjust the coating solution discharge position of the upper discharge part 71.

Like the upper plate 10, the middle plate 20 may be provided with a lower manifold 42 thereinside so that the coating solution may be discharged through the lower discharge part 72.

Accordingly, like the upper manifold 41, the lower manifold 42 may supply the coating solution in the direction of gravity to the lower discharge part 72 and due to this, freedom to change in design may be effectively secured to combine the height adjustment part 50 to the lower plate 30 or to change to a structure in which the lower plate 30 itself is height adjustable.

The height adjustment part 50 may adjust the upper and lower heights of the main body 1 to adjust the discharge positions of the coating solution of the upper discharge part 71 and the lower discharge part 72. This is to appropriately adjust the positions with respect to the coating roll 80, the coating target, in the case of dual-type coating that uses both the upper discharge part 71 and the lower discharge part 72, and the relative position with respect to the coating roll 80 in single-type coating that uses only the upper discharge part 71.

As shown in FIG. 3, at the lower part of the main body 1, a first adjustment part 51 and a second adjustment part 52 may be respectively connected to one side and the other side of an adjustment joint part 31 of the lower plate 30. At least one height adjustment part 50 may be provided, but in this disclosure, the first adjustment part 51 and the second adjustment part 52 are illustrated and explained as an example.

The first adjustment part 51 and the second adjustment part 52 may be driven by a motor to adjust the height thereof, and may have a general screw shape and be combined in a form that can be driven upward or downward according to the rotation direction. The first adjustment part 51 and the second adjustment part 52 may be controlled to driven to the same height, and the height difference between the first adjustment part 51 and the second adjustment part 52 may be set as needed depending on the position of the coating roll 80, the coating target.

FIG. 3 is an example of a case where coating is performed by discharging the coating solution from both the upper discharge part 71 and the lower discharge part 72. Based on L1 and L2 lines, the main body 1 of the coating apparatus module may be adjusted so that the L1 line is positioned between the upper discharge part 71 and the lower discharge part 72 or closer to the lower discharge part 72. FIG. 3 shows a case of dual-type coating in which coating solution is discharged through the upper discharge part 71 and the lower discharge part 72.

FIG. 4 shows a case of single-type coating in which coating is performed using only the upper discharge part71. In this case, the upper height of the main body 1 may be adjusted by means of the first adjustment part 51 and the second adjustment part 52 so that the upper discharge part 71 is positioned at the L1 line.

As the first adjustment part 51 and the second adjustment part 52 may be adjusted and controlled by being connected to the adjustment joint part 31 of the lower plate 30, and the upper manifold 41 and the Lower manifold 42 are positioned in the upper plate 10 and the middle plate 20, respectively, the structure or method for adjusting the height of the main body 1 by means of the lower plate 30 may be effectively selected and applied.

FIG. 5 is a view showing an example of a case where coating is actually performed while facing the coating roll 80.

Above the coating apparatus module, a first sensor part 91 may be provided that measures the overall height of the coating apparatus module while moving in one direction and the other direction of the upper part of the main body 1 of the coating apparatus module.

A second sensor part 92 that measures the height of the coating roll 80 may also be provided above the coating roll 80.

The relative position between the coating apparatus module and the coating roll 80 is sensed by means of the first sensor part 91 and the second sensor part 92, and depending on whether single- type coating or dual-type coating is performed, a controller 93 may adjust and control the height of the coating apparatus module in real time using the height of the height adjustment part 50.

By doing so, both single-type and dual-type coating processes may be effectively performed by a single device of the coating apparatus module.

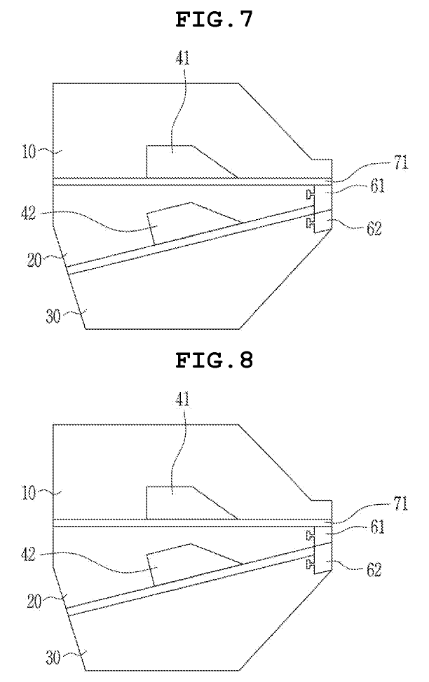

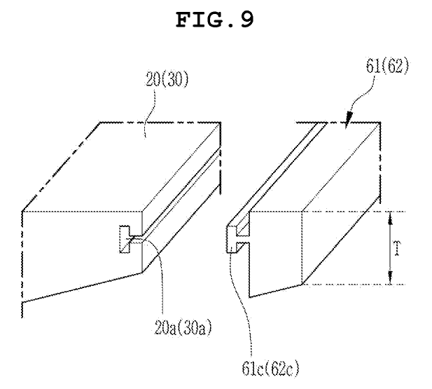

FIG. 6 is a cross-sectional view before adjustment of an adjustment lip of a coating apparatus module according to another embodiment of the present disclosure; FIGS. 7 and 8 are cross-sectional views after adjustment of an adjustment rib of a coating apparatus module according to another embodiment of the present disclosure; and FIG. 9 is an exploded perspective view of an adjustment rib of a coating apparatus module according to another embodiment of the present disclosure.

A coating apparatus module according to another embodiment of the present disclosure may include a main body 1 including: a lower plate 30; a middle plate 20 joined on the lower plate 30; an upper plate 10 joined on the middle plate 20; an upper core member that is coupled to the upper plate 10 and the middle plate 20 at a position therebetween to form an upper discharge part 71 through which a coating solution is discharged; and a lower core member that is coupled to the middle plate 20 and the lower plate 30 at a position therebetween to form a lower discharge part 72 through which a coating solution is discharged. In addition, adjustment ribs 61 and 62 may be formed at one end of the middle plate 20 or the lower plate 30, on the side of the lower discharge part 72, and may be separately coupled to open and close the lower discharge part 72.

The main body 1 consisting of the upper plate 10, the middle plate 20, the lower plate 30, the upper core member 11, and the lower core member 21 of the coating apparatus module according to another embodiment of the present disclosure is substantially the same as that of the coating apparatus module according to the embodiment of the present disclosure described above.

In addition, the configuration of the height adjustment part 50, the first sensor part 91, the second sensor part 92, the controller 93, the upper manifold 41, and the lower manifold 42 of the coating apparatus module according to the embodiment of the present disclosure may all be included in the coating apparatus module according to another embodiment of the present disclosure, and thus a detailed description of the configuration will be omitted.

Hereinafter, each configuration of the coating apparatus module according to another embodiment of the present disclosure will be described, focusing on a differentiated configuration that does not overlap with the coating apparatus module in an embodiment of the present disclosure.

The coating apparatus module according to another embodiment of the present disclosure may further include the adjustment ribs 61 and 62 at one end of the middle plate 20 or the lower plate 30, on the side of the lower discharge part 72, to open and close the lower discharge part 72.

The adjustment ribs 61 and 62 may be formed in a separate bonding manner rather than being integrally formed at the tip of the middle plate 20 or the lower plate 30. That is, the adjustment ribs 61 and 62 may be coupled to one end of the middle plate 20 or the lower plate 30 in a separate fastening manner, and by doing so, the main body 1 may be operated with the adjustment ribs 61 and 62 of appropriate specifications as needed.

As shown in FIG. 6, the adjustment ribs 61 and 62 may be provided on the middle plate 20 or the lower plate 30, or on each of the middle plate 20 and the lower plate 30. The adjustment ribs 61 and 62 may be separately attached to both the middle plate 20 and the lower plate 30 as shown, but the adjustment ribs 61 and 62 may also be separately attached to only one of the middle plate 20 or the lower plate 30.

FIG. 6 shows dual-type coating, that is, the drawing shows the appearance of the coating apparatus module in the case where the coating solution is discharged using both the upper discharge part 71 and the lower discharge part 72. In this case, both the upper discharge part 71 and the lower discharge part 72 are physically open so that the coating solution may be discharged.

FIGS. 7 and 8 show single-type coating, that is, the drawings show cases where coating is performed using only the upper discharge part 71. In this case, coating may be performed by adjusting the height as in the case of the coating apparatus module according to an embodiment of the present disclosure previously described, but it is necessary to ultimately adjust the discharge of the coating solution by the lower discharge part 72.

In the case of the coating apparatus module according to another embodiment of the present disclosure, the configuration of the height adjustment part 50 of the coating apparatus module in an embodiment of the present disclosure already described above may be combined. Even in cases where the height is adjusted in a different way, when coating is performed using only the upper discharge part 71, a more stable and reliable coating process may be carried out by controlling the opening and closing of the lower discharge part 72 as well as the position adjustment.

As shown in FIG. 7, the adjustment rib 61 may be combined on the middle plate 20, and the thickness of the adjustment rib 61 may be adjusted to a thickness suitable for closing the lower discharge part 72 and combined on the tip of the middle plate 20. By doing so, the adjustment rib 61 may close the lower discharge part 72, enabling smooth performance of the single-type coating.

As shown in FIG. 8, the adjustment rib 62 may be combined on the tip of the lower plate 30. In this case as well, the adjustment rib 62 may effectively close the lower discharge part 72 by being combined after the thickness of the adjustment rib 62 is adjusted in the upward direction.

FIG. 9 is an example of a case where the adjustment ribs 61 and 62 are specifically coupled to the middle plate 20 or the lower plate 30. The adjustment ribs 61 and 62 may respectively have fastening parts 61c and 62c so as to fit into fastening grooves 20a and 30a formed on the middle plate 20 and the lower plate 30, respectively.

As shown in FIG. 9, it is appropriate that the fastening parts 61c and 62c of the adjustment ribs 61 and 62 are coupled to the fastening grooves 20a and 30a extending in one direction inward on the middle plate 20 and the lower plate 30, so that the adjustment ribs 61 and 62 may be fixed without moving forward or backward.

The drawing is exemplary and does not impose any particular restrictions on the method of physically attaching the adjustment ribs 61 and 62 to the middle plate 20 or the lower plate 30.

However, it is appropriate that the adjustment ribs 61 and 62 are combined so that there is no separation spacing in the front or rear of the lower discharge part 72 after the combination, and depending on the need, various combination methods other than the illustrated method may be selected and applied as long as separation is possible.

Above, the present disclosure has been described in detail through specific embodiments. The embodiments are for specifically explaining the present disclosure, and are only illustrative and do not limit the scope of the appended claims. It is obvious to those skilled in the art that various changes and modifications to the embodiments are possible within the scope and technical idea of the present disclosure, and it is natural that such changes and modifications fall within the scope of the appended claims.

What is claimed is:

1. A coating apparatus module comprising:
a main body comprising:
a lower plate;
a middle plate joined on the lower plate;
an upper plate joined on the middle plate;
an upper core member coupled to the upper plate and the middle plate at a position therebetween to form an upper discharge part through which a coating solution is discharged; and a lower core member coupled to the middle plate and the lower plate at a position therebetween to form a lower discharge part through which a coating solution is discharged,
wherein the main body is combined with at least one height adjustment part to adjust heights of the upper discharge part and the lower discharge part.

2. The module of claim 1, further comprising:
a first sensor part configured to sense a height of the main body;
a second sensor part configured to sense a height of a coating roll coated by the main body;
and a controller configured to sense a height difference between the heights sensed by the first
sensor part and the second sensor part and to drive the height adjustment part of the main body.

3. The module of claim 1, wherein the height adjustment part comprises:
a first adjustment part coupled to a first side of the lower plate of the main body; and
a second adjustment part coupled to a second side of the lower plate of the main body,
wherein the first adjustment part and the second adjustment part are coupled to an adjustment joint part of the lower plate.

4. The module of claim 3, wherein the first adjustment part and the second adjustment part have a screw shape and rotate to adjust a height of the main body.

5. The module of claim 1, further comprising:
an upper manifold provided on an inner surface of the upper plate facing the upper plate
and the middle plate to supply a coating solution to the upper discharge part; and a lower manifold provided on an inner surface of the middle plate facing the middle plate and the lower plate to supply a coating solution to the lower discharge part.

6. A coating apparatus module comprising:
a main body comprising: a lower plate; a middle plate joined on the lower plate; an upper plate joined on the middle plate; an upper core member coupled to the upper plate and the middle plate at a position therebetween to form an upper discharge part through which a coating solution is discharged; and a lower core member coupled to the middle plate and the lower plate at a position therebetween to form a lower discharge part through which a coating solution is discharged; and
an adjustment rib provided at an end of the middle plate or the lower plate, on a side of the lower discharge part, and separately coupled to open and close the lower discharge part.

7. The module of claim 6, wherein the adjustment rib is coupled to the middle plate or the lower plate, and includes a fastening part so as to join to a fastening groove provided at an end of the middle plate or the lower plate.

8. The module of claim 7, wherein the fastening groove is provided on an inner side of a side of the middle plate or the lower plate, and is formed so that the fastening part is fitted into an end thereof.

9. The module of claim 6, wherein the main body is combined with at least one height adjustment part to adjust heights of the upper discharge part and the lower discharge part.

10. The module of claim 7, wherein the height adjustment part comprises:
a first adjustment part coupled to a first side of the lower plate of the main body; and
a second adjustment part coupled to a second side of the lower plate of the main body,
wherein the first adjustment part and the second adjustment part are coupled to an
adjustment joint part of the lower plate.

11. The module of claim 6, further comprising:
an upper manifold provided on an inner surface of the upper plate facing the upper plate and the middle plate to supply a coating solution to the upper discharge part; and
a lower manifold provided on an inner surface of the middle plate facing the middle plate and the lower plate to supply a coating solution to the lower discharge part.

12. The module of claim 9, further comprising:
a first sensor part configured to sense a height of the main body;
a second sensor part configured to sense a height of a coating roll coated by the main body;
and a controller configured to sense a height difference between the heights sensed by the first
sensor part and the second sensor part and to drive the height adjustment part of the main body.
